(19) United States
(12) Patent Application Publication
(10) Pub. No.: US 2022/0020079 A1
(43) Pub. Date: Jan. 20, 2022

(54) Paperless Tasting Menu Order Ship Events

(71) Applicant: Toni Barnes, Suisun City, CA (US)

(72) Inventor: Toni Barnes, Suisun City, CA (US)

(21) Appl. No.: 16/929,297

(22) Filed: Jul. 15, 2020

(51) Int. Cl. G06Q 30/06; G06Q 10/08; G06Q 10/02

(52) U.S. Cl. CPC G06Q 30/0633; G06Q 10/02; G06Q 10/087

(57) ABSTRACT

The present invention discloses an paperless ordering computer application that interacts with AMS (Advanced Management Systems) which is a premier provider for wine industry information systems. The said system interacts with the wineries to keep track of inventory, wines, prices, merchandise, shipping, and events, reservations, etc. This will be a payment system that connects with AMS, which is also connected to the wineries to order.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to an information collection and management system accessible through the Internet. More particularly, the present invention relates to an information collection computer application that will reserve the orders directly to the winery making paper ordering system redundant.

### DESCRIPTION OF THE RELATED ART

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The number of small wineries in the United States is growing rapidly. In 2005 there were 4,000 small wineries, each typically producing less than 5,000 cases a year. However, in contrast, the number of wine distributors has decreased through a series of mergers. Small wineries complain that the national distributors are too expensive to work with and ignore small companies in favor of a few big brands. As a result, 80 percent of wine sales come from just 100 brands such as E&J Gallo Winery, Robert Mondavi Corp. and Beringer Blass Wine Estates Ltd.

As a result of the above distribution network, small wineries of America fit into a much smaller niche in the market, and must resort to alternative sales methods. For example, the smaller wineries of Napa Valley in California produce wines, but often also provide an experience to wine connoisseurs and tourists alike who frequently visit their region. This helps to promote the sales of their wines either directly from the winery, their tasting room, or through a local distributor.

A given distribution center may have many order fulfillment mechanisms. In one example, the distribution center includes a conveyor that transports a container to various locations, each of which has an order fulfillment mechanism. One location may have a bank of carousels, each containing numerous bins of inventory. Each bin holds one or more types of inventory. When a container arrives at a carousel, rotates its inventory into a position where order items can be placed in the container. Another order fulfillment mechanism in the distribution center may have a few aisles each containing multiple bins. A worker moves through the aisles to pick out requested items and place them in the container. Other types of order fulfillment mechanisms may be employed. A “pod” is a group of inventory locations all serviced from the same stop on the transport system (e.g., a conveyor stop). A pod may contain any or more of the various types of order fulfillment mechanism. Each pod has one or more types of inventory available for “picking.” Picking refers to the operation of retrieving an item of inventory from a pod and placing it into a container. The container holds the various items that fulfill a given order.

Given that different customers have very different needs and preferences, different orders provide wide and rather unpredictable variation. Optimal load balancing to meet this variation presents a serious challenge. During a given week, for example, several grocery orders may require milk, but only a few of these require anchovies, a few others require spicy tofu, and still a few others require cotton swabs. In fulfilling these various orders, any one of these items could present a throughput bottleneck. Controlling the position and path of a container used to fulfill an order can at least partially address this problem.

The present invention fills a need for better ways to fulfill customer orders within a distribution center. None of the prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

The present invention is a computer application that interacts with AMS (Advanced Management Systems) which is a premier provider for wine industry information systems. The said system interacts with the wineries to keep track of inventory, wines, prices, merchandise, shipping and events, reservations, etc. Wineries use AMS to complete purchases while physically at the winery. The inventor proposes a computer application that will replace the conventional paper ordering while customers are at the winery. Customers will be able to place their order through the proposed computer application using the information provided by AMS that will go directly to the winery to place their order. This will be a payment system that connects with AMS, which is also connected to the wineries to order.

Another embodiment of the proposed invention is complete paperless forms for wineries, tasting rooms, and customers, using an computer application. The proposed app will interact with AMS-Advanced Management Systems, which is premier provider of wine industry information systems. Customers registers their information, saves it in PTMOSE when customer visits wineries their information is populated. Wineries capture customer information so less error, less writing, safe and secure.

It is principal object of the invention that both customers and winery employees will use a portable device. PTMOSE is made to interact with AMS-Advanced Management Systems, premier provider of wine industry information systems, inventory of wines, wine club, merchandise, shipping, etc.

Another significant embodiment of the present invention relates to customers visiting the wineries for using their portable device for tasting menus, and any other forms needed to be fill out. Once customer registers with PTMOSE, their information populate on forms, less writing, less errors and easy to navigate. If customer is a wine club member their membership number will populate. Customers register their information with PTMOSE. Name, address, city, state, zip, home and cell phone numbers, credit card, expiration date, CVC, date of birth, email address, notes for ease of use.

In an alternative embodiment, the present invention is designed to be used both by the customers and wineries.

It is principal object of the invention to provide new approaches and concepts for facilitating the paperless order taking of the wine and the subsequent completion of wine sales using a computer application.

Another significant embodiment of the present invention provide a warehouse management system that could include customer orders that may specify at least a product ID and a quantity for each item of the customer order

It is an object of the invention to provide a process and electronic data processing software program for carrying out ordering while customers are at the winery.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is a flowchart showing one aspect of an associated method for ordering and distributing wine, suitable for use in the system.

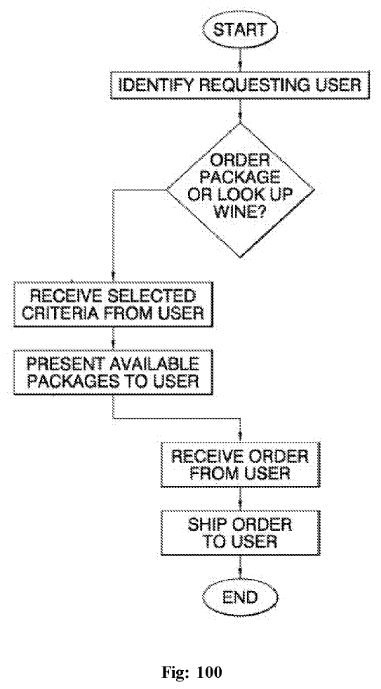

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claim/s.

The present invention is a computer application that interacts with AMS (Advanced Management Systems) which is a premier provider for wine industry information systems. The said system interacts with the wineries to keep track of inventory, wines, prices, merchandise, shipping, and events, reservations, etc. Wineries use AMS to complete purchases while physically at the winery. The inventor proposes a computer application that will replace the conventional paper ordering while customers are at the winery. Customers will be able to place their order through the proposed computer application using the information provided by AMS that will go directly to the winery to place their order. This will be a payment system that connects with AMS, which is also connected to the wineries to order.

Another embodiment of the proposed invention is complete paperless forms for wineries, tasting rooms, and customers, using an computer application. The proposed app will interact with AMS-Advanced Management Systems, which is premier provider of wine industry information systems. Customers registers their information saves it in PTMOSE when customer visits wineries their information is populated. Wineries capture customer information so less error, less writing, safe and secure.

It is principal object of the invention that both customers and winery employees will use a portable device. PTMOSE is made to interact with AMS-Advanced Management Systems, premier provider of wine industry information systems, inventory of wines, wine club, merchandise, shipping, etc.

The method of the present invention is simple and modest a “SHIP TO STATE’ line that reads yes/no/limits. That tells the customer if they or the winery can ship wine to that registered state {this feature will only activate at each different winery customers are visiting}. After arriving at winery download the winery website. On home page of website will be PTMOSE. Click it. The information page pops up that may ask Customer's name, address, city state, yes/no/limits{one of these will show} zip, credit card, expiration date, CVC, date of birth, home and cell phone numbers, email any notes{birthday, engagement etc}. PTMOSE interacts with AMS{Advanced Management Systems} The Host button, will have names of hosts. Click on your host. At this point your host can follow along with guest. Next will be customer type: Tasting fees, Industry, Trade, Wine Club Member, Coupon, Group, Event, Complimentary. PTMOSE and AMS are interacting to populate information. IF customer is a wine club member, their membership number populates. Next is the tasting menu, after each wine listed will be 3 boxes 1st=Rate the wine, Thumb up/down, 2nd-Buy click, 3rd number of bottles{Buy and #Bottles are use together, cannot use one without the other} If your number of bottles are LESS than, this is AMS and PTMOSE interacting. Indicating available inventory. At the bottom of the tasting menu page will be other buttons to navigate to Merchandise, Library and Large Format Wines, {library and large format wines will only have {2} buttons a Buy button and #Bottles button} Promotions, Wine Club form, Ship form, Events. Each form has a Buy Button which activates all information populated. There will be additional areas to fill in, only information registered with PTMOSE will populate. Ultimately all purchases are itemized on the E-Commerce page. Subtotal, Tip Line, Total, A transaction #, customer signature line, button that reads—COMPLETE ORDER, auto save complete order for 30 days. #5 Clicking the Ship button {2} times gives customer a non-populated ship form to fill out. Host can follow along with guest on their own tablet, wine club membership numbers populate, numbers of bottles reflect inventory and will message the demand to the rest.

Club memberships will have a ? with the membership number, if there is a problem with the account{declined, expired etc} The ? must be resolved before checkout. Also club membership discounts are reflected at checkout. Group and Event customers viii have a preassigned number to take advantage of any special discounts for them.

In conclusion, the present invention provides a vineyard information collection and management system that allows for the collection, management, analysis, and reporting of vineyard information. Vineyard information can be collected from a virtually unlimited number of sources, such as remote computers, PDAs, third party sources, remote sensors, and other data sources. The system processes, analyzes, and reports collected information using convenient, easy-to-use forms and reports accessible anywhere via the Internet. The system is expandable to accommodate a user's requirements and to collect, manage, analyze, and report any desired type of vineyard information.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) An computer application that interacts with AMS (Advanced Management Systems) which is premier provider for wine industry information systems and interacts with the wineries to keep track of inventory, wines, prices, merchandise, shipping, and events, reservations.

2) The computer application is designed to be used both by the customers and wineries and said system interacts with the wineries to keep track of inventory, wines, prices, merchandise, shipping, and events reservations.

3) The computer application is paperless system that will take away the paper ordering while customers are at the winery customers will be able to place their order through computer application using the information provided by AMS that will go directly to the winery to place their order.
